(19) United States
(12) Patent Application Publication
(10) Pub. No.: US 2008/0276363 A1
(43) Pub. Date: Nov. 13, 2008

(54) SPRAY NOZZLE STRUCTURE FOR USE IN A MASSAGE BATHTUB

(76) Inventor: JACK CHEN, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/746,099

(22) Filed: May 9, 2007

(51) Int. Cl. A61H 33/00

(52) U.S. Cl. 4/541.6

(57) ABSTRACT

A spray nozzle structure for use in a massage bathtub comprises a housing including a sleeve member having a receiving compartment formed therein and a hollow L-shaped rod member extended upwardly therefrom; a fixing seat constructed in the form of a ring and fitted in the opening of the sleeve member of the housing; a motor including a rotary shaft with which an impeller is combined, and disposed in the receiving compartment; a guiding collar engaged in a retaining recess of the fixing seat; a cover member containing an inlet affixed at the center of the outer surface thereof, about which two opposite openings are formed, each having an air duct affixed at the side thereof and having a guiding piece selectively mounted on the outer side thereof, thereby obtaining a handing function and a proper water flowing angle.

### BACKGROUND OF THE INVENTION

1. Field of the Invention

The present invention relates to a spray nozzle, and more particularly to a movable spray nozzle that may be hung onto the inner wall of a massage bathtub and strongly spout out water.

2. Description of the Prior Arts

With the development of modern life, a massage bathtub having cure function is becoming more popular with people, however the prior art massage bathtub still has the following disadvantages:

1. The prior art massage bathtub includes a water returning tube, a watering pipe and an air duct all arranged in the interior thereof, hence it is difficult to assemble and is inconvenient to clean.

2. By using a motor, the water in the bathtub may be drawn through a water returning head and the water returning pipe, and then be spouted back to the bathtub via the watering pipe and a spray nozzle; therefore the strength of spouting water is limited.

To improve above-mentioned defects, a swirly spray nozzle has been developed. It has not to arrange complicate water pipes therein, and a motor thereof is applied to urge the rotation of a rotor of an impeller to generate a whirlpool so as to draw the water in the massage bathtub from an inlet of a cover member, and then the water is pressurized to spout out from a housing, thereby enhancing the strength of the spouted water.

Nevertheless, such a swirly spray nozzle may only be fixedly inserted onto the inner wall of the massage bathtub, but cannot moveably be hung thereof. Besides, the watering angle cannot be adjusted at different angles as well.

The present invention has arisen to mitigate and/or obviate the afore-described disadvantages.

### SUMMARY OF THE INVENTION

The primary object of the present invention is to provide a spray nozzle structure for use in a massage bathtub that has a hanging function so as to be hung onto the wall of the massage bathtub, and may be replaceably to use as an inlay type spray nozzle as well.

Another object of the present invention is to provide a spray nozzle structure for use in a massage bathtub, each opening of which includes a guiding piece selectively installed on the outer side thereof for flowing water at different angles, and the guiding piece may also be randomly replaced based on demand.

In accordance with one aspect of the present invention, there is provided a spray nozzle structure for use in a massage bathtub comprising a spray nozzle structure for use in a massage bathtub in accordance with the present invention comprises a housing, a fixing seat, a motor, a guiding collar and a cover member, wherein the housing includes a circular sleeve member having a receiving compartment formed therein, about which a plurality of locking pegs are mounted. Furthermore, the sleeve member includes a hollow L-shaped rod member extended upwardly therefrom, communicating with the receiving compartment, and having a hooking member, which includes bores formed on the side thereof, attached on the top thereof. The fixing seat is constructed in the form of a two-stepped ring, and includes a plurality of retaining recesses fixed on the inner wall of the front end thereof and includes a peripheral flange secured on the rear end thereof, and further includes a plurality of holes and two apertures arranged on the large-diameter stepped end surface thereof, a number of engaging slots defined around the periphery thereof, a fitting rim provided on the back surface thereof, a number of positioning pieces and two inserting pillars disposed on the small-diameter stepped periphery thereof and coupling with the apertures. The motor includes a rotary shaft with which an impeller is combined, the guiding collar includes a plurality of snap-on tabs mounted around the rim thereof, and includes two opposite protrusions attached on the inner wall thereof the cover member contains a number of fastening bulges fixed on the inner wall thereof, and contains an inlet affixed at the center of the outer surface thereof, about which two opposite watering grooves are provided and each has an opening and a through orifice for the insertion of a L-shaped air duct, and about each of the watering grooves is formed two opposite dents so as to selectively mount an arcuate guiding pieces at different angles.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of a spray nozzle structure for use in a massage bathtub according to the present invention;

FIG. 2 is another perspective diagram illustrating the exploded components of the spray nozzle structure for use in the massage bathtub according to the present invention;

FIG. 3 is a perspective diagram illustrating the assembly of the spray nozzle structure for use in the massage bathtub according to the present invention;

FIG. 4 is a cross-sectional diagram illustrating the assembly of the spray nozzle structure for use in the massage bathtub according to the present invention;

FIG. 5 is a cross-sectional diagram illustrating the using state of the spray nozzle structure for use in the massage bathtub according to the present invention;

FIG. 6 is a longitudinally partial cross-sectional diagram illustrating the using state of the spray nozzle structure for use in the massage bathtub according to the present invention;

FIG. 7 is a horizontally cross-sectional diagram illustrating the using state of the spray nozzle structure for use in the massage bathtub of the present invention;

FIG. 8 is a perspective diagram illustrating the present invention hung onto a massage bathtub;

FIG. 9 is a perspective diagram illustrating the present invention hung onto a feet massage tub;

FIG. 10 is a perspective diagram illustrating the assembly of the spray nozzle structure for use in the massage bathtub according to another embodiment of the present invention;

FIG. 11 is a perspective diagram illustrating the spray nozzle structure with retaining projections inserted onto the massage bathtub according to another embodiment of the present invention.

### DETAILED DESCRIPTION OF THE PREFERRED EMBODIMENT

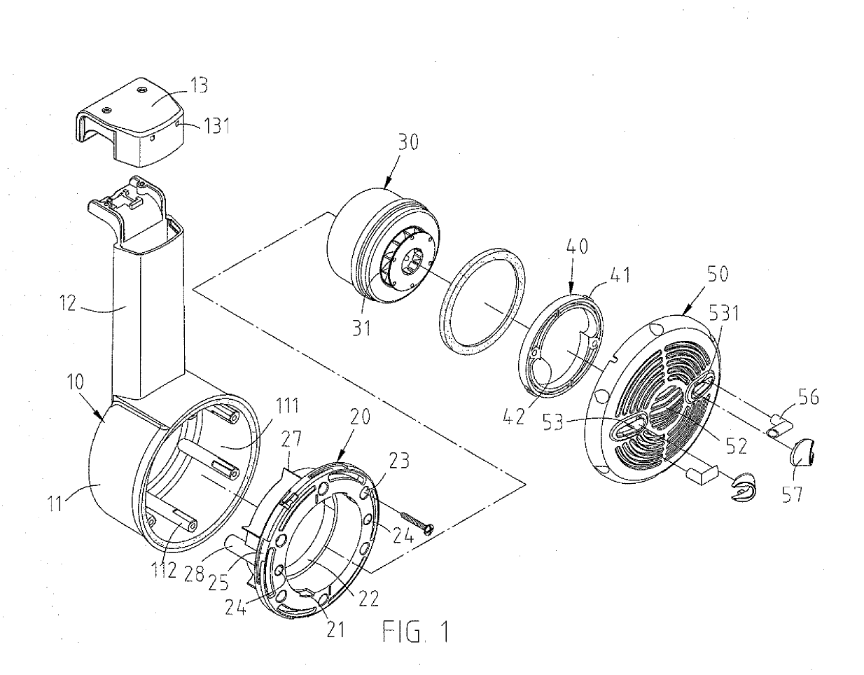

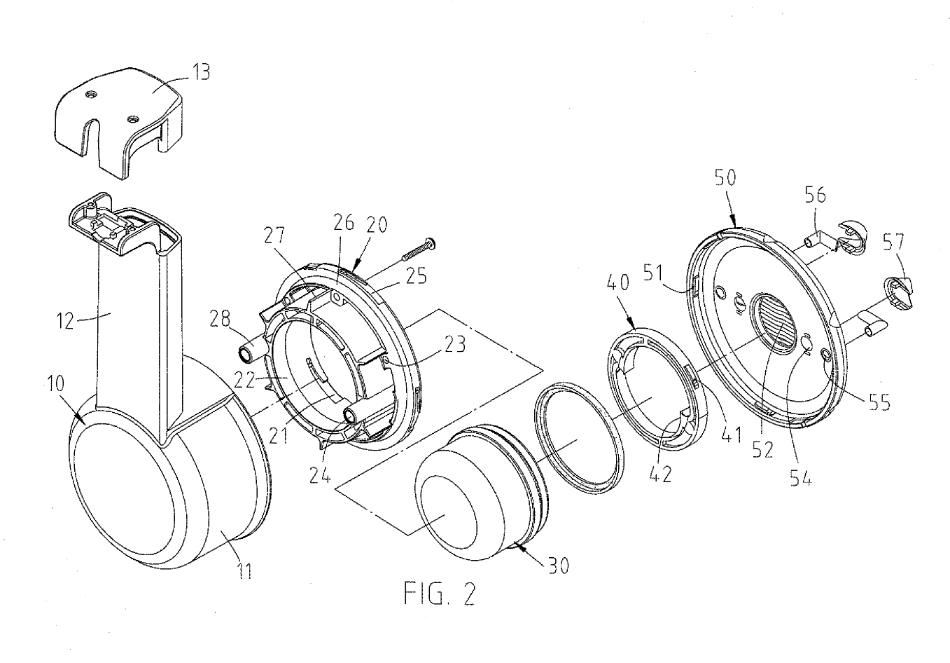

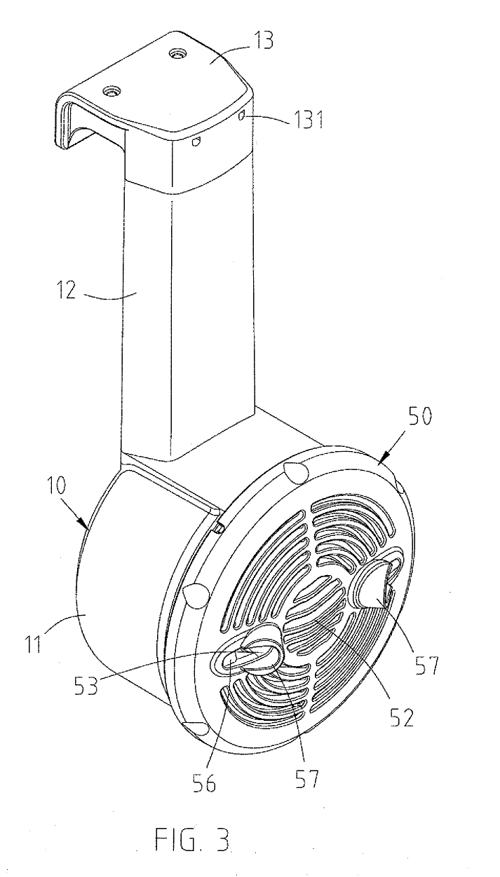

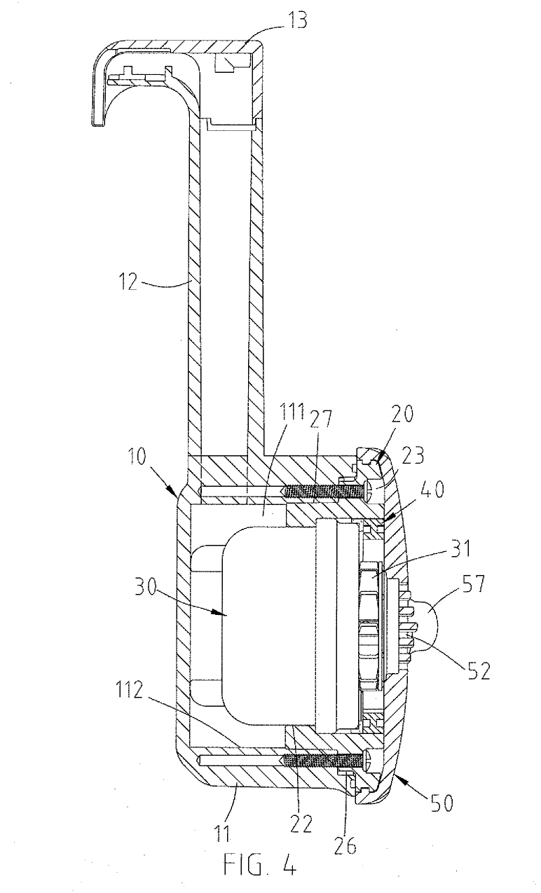

Referring to FIGS. 1-4, a spray nozzle structure for use in a massage bathtub in accordance with the present invention comprises a housing 10, a fixing seat 20, a motor 30, a guiding collar 40 and a cover member 50, wherein the housing 10 includes a circular sleeve member 11 having a receiving compartment 111 formed therein, about which a plurality of locking pegs 112 are mounted. Furthermore, the sleeve member 11 includes a hollow L-shaped rod member 12 extended upwardly therefrom, communicating with the receiving compartment 111, and having a hooking member 13, which includes bores 131 formed on the side thereof, attached on the top thereof. The fixing seat 20 is constructed in the form of a two-stepped ring, and includes a plurality of retaining recesses 21 fixed on the inner wall of the front end thereof, and includes a peripheral flange 22 secured on the rear end thereof and further includes a plurality of holes 23 and two apertures 24 arranged on the large-diameter stepped end surface thereof a number of engaging slots 25 defined around the periphery thereof, a fitting rim 26 provided on the back surface thereof, a number of positioning pieces 27 and two inserting pillars 28 disposed on the small-diameter stepped periphery thereof and coupling with the apertures 24. The motor 30 includes a rotary shaft with which an impeller 31 is combined, the guiding collar 40 includes a plurality of snap-on tabs 41 mounted around the rim thereof, and includes two opposite protrusions 42 attached on the inner wall thereof, the cover member 50 contains a number of fastening bulges 51 fixed on the inner wall thereof, and contains an inlet 52 affixed at the center of the outer surface thereof, about which two opposite watering grooves 53 are provided and each has an opening 54 and a through orifice 55 for the insertion of a L-shaped air duct 56, and about each of the watering grooves 53 is formed two opposite dents 531 so as to selectively mount an arcuate guiding pieces 57 at different angles.

In assembly, the fixing seat 20 is fitted in the opening of the sleeve member 11 of the housing 10 so that the large-diameter step portion of the fixing seat 20 retains on the end periphery of the opening of the sleeve member 11, and the fitting rim 26 of the fixing seat 20 is fitted on the inner periphery of the opening of the sleeve member 11, each positioning piece 27 of the fixing seat 20 is engageably positioned with the respective locking peg 112 in the sleeve member 11, and by fastening screws through the hole 23 of the fixing seat 20, the fixing seat 20 is secured on the locking peg 112 of the sleeve member 11, then the motor 30 is disposed in the receiving compartment 111 and retained on the peripheral flange 22, and by way of the snap-on tabs 41, the guiding collar 40 is engaged in the retaining recess 21 of the fixing seat 20 such that the motor 30 is firmly secured, and the two protrusions 42 are in response to the impeller 31 of the motor 30, then the fastening bulges 51 are correspondingly engaged in the engaging slots 25 so that each of the air ducts 56 inserts and couples with the individual aperture 24 of the fixing seat 20, thereby assembling the spray nozzle of the present invention.

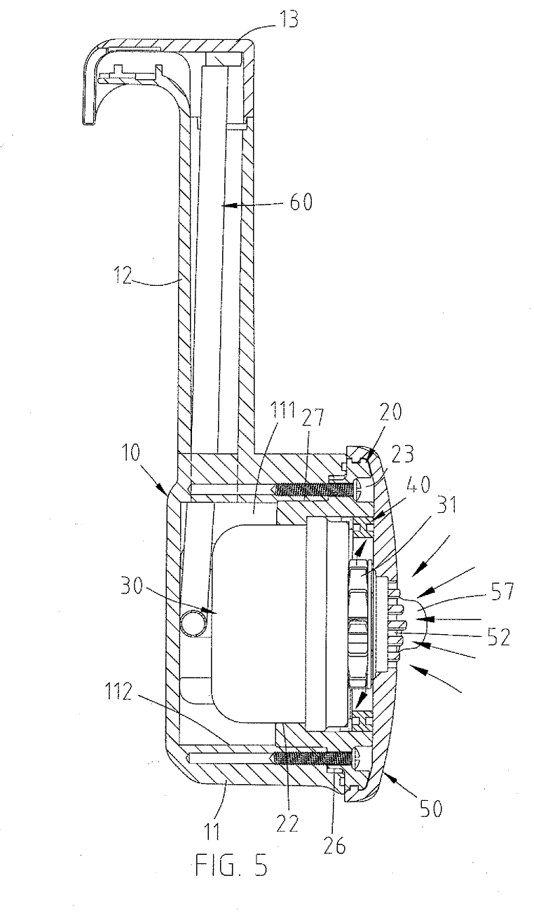

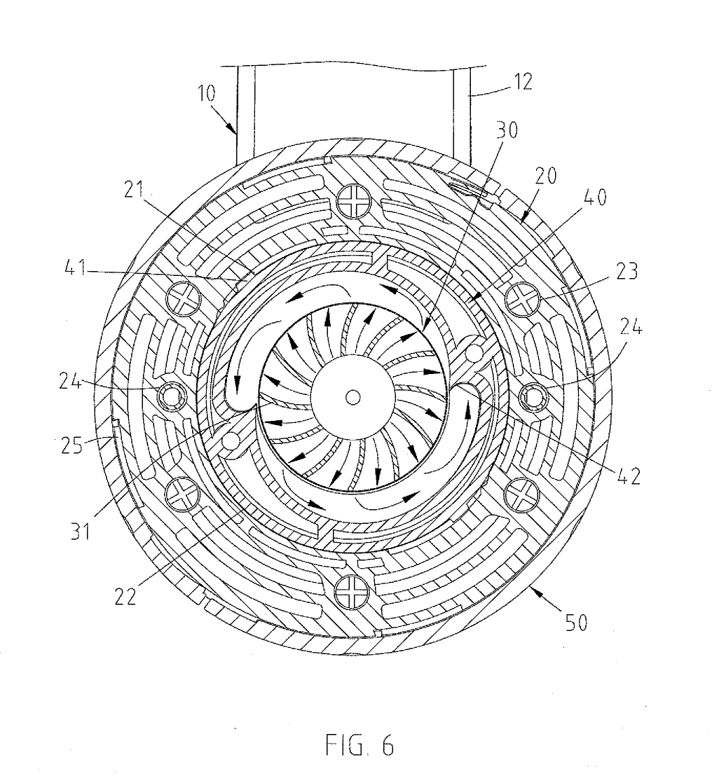

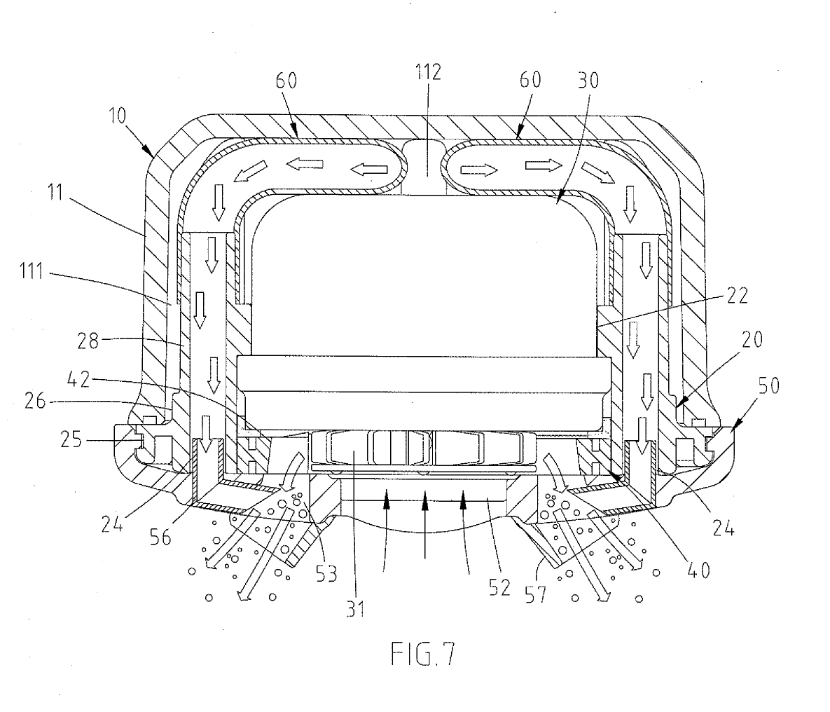

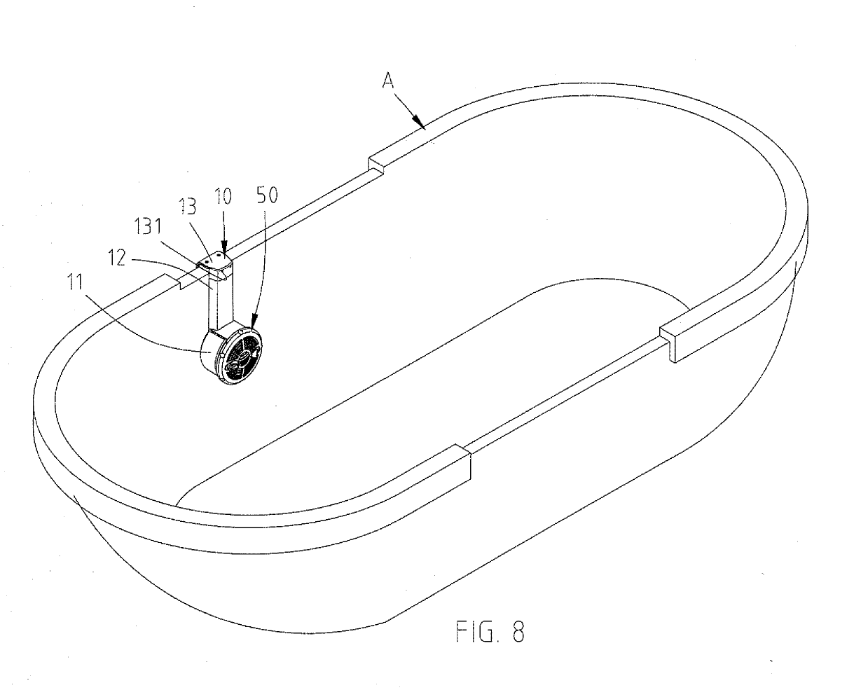

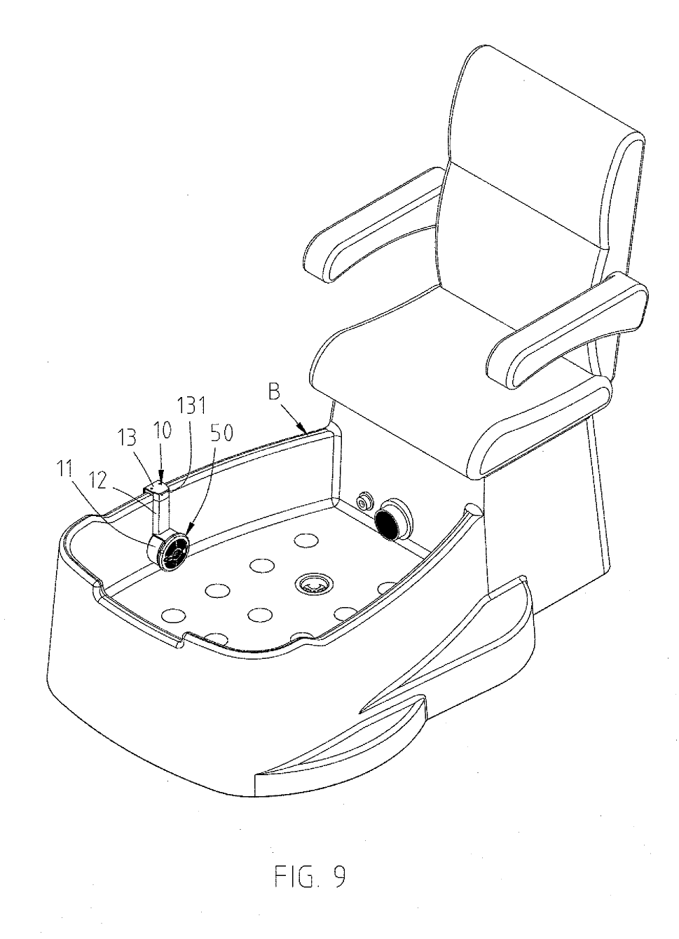

As shown in FIGS. 5-9, while in use, an air tube 60 and the motor wire (not shown) are connected to outside through the hollow rod member 12, and the air tube 60 and the two inserting pillars 28 of the fixing seat 20 are connected with each other so as to utilize the rod member 12 associated with the hooking member 13 to hang the spray nozzle onto the side wall of a massage bathtub A or a feet massage tub B, and by using the rotation of the motor 30, the motor 30 may actuate the impeller 31 to generate a suction force, such that the water in the massage bathtub A or the feet massage tub B may be drawn from the inlet 52 of the cover member 50 and guided by the two protrusions 42 of the guiding collar 40 to cause a swirly pressure, hence the water may be strongly spouted out from the two openings 54 of the cover member 50 via the guiding of the watering grooves 53 and the guiding pieces 57. In the meantime, by virtue of the siphon effect, the outside air may be drawn into the two watering grooves 53 from the bore 131 and the air tube 60 through the inserting pillars 28, the apertures 24 and the two air ducts 56 of the cover member 50, thus achieving a spout with bubbles.

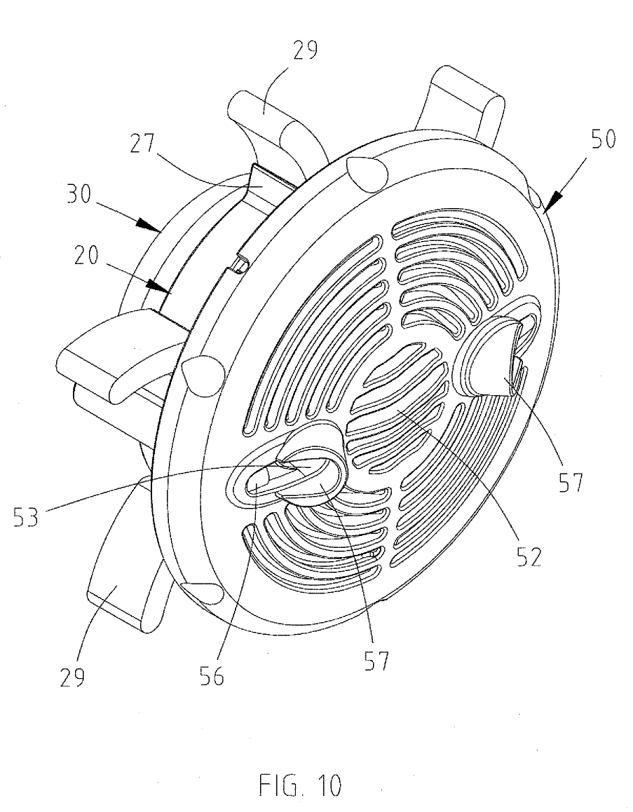

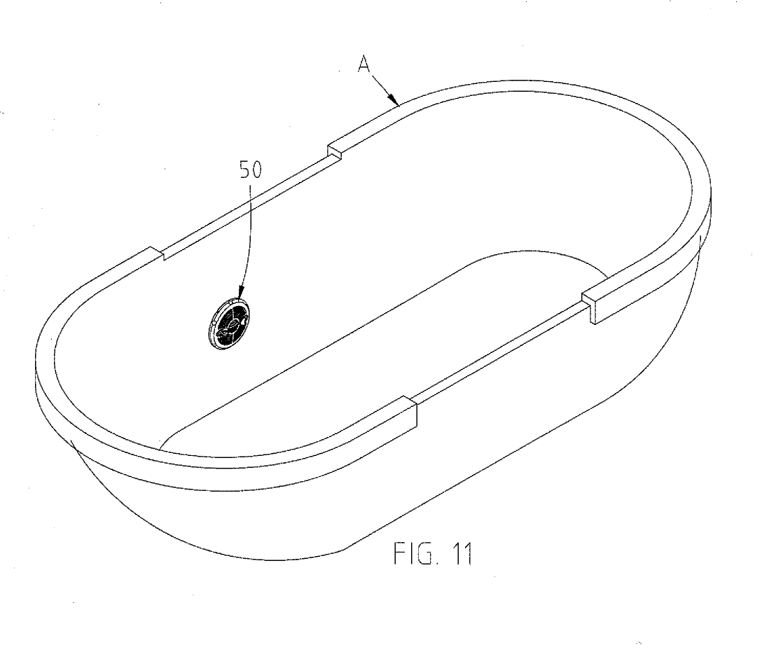

With reference to FIGS. 10 and 11, a plurality of retaining projections 29 may also be directly formed on the periphery of the fixing seat 20 for forming an inlay type spray nozzle, such that the retaining projections 29 may be inserted into the predetermined installing holes on the inner wall of the massage bathtub A.

It can be clearly seen from the preceding accounts on the features of the present invention that the spray nozzle structure for use in the massage bathtub of the present invention has the following advantages:

1. The present invention is provided with a hanging function for being hung onto the wall of the massage bathtub or the feet massage tub, and the retaining projections 29 may be also directly affixed on the periphery of the fixing seat 20 for forming an inlay type spray nozzle.

2. Each of the openings 54 includes a guiding piece 57 selectively installed on the outer side thereof for flowing water at different angles, and the guiding piece 57 may also be randomly replaced based on demand.

The invention is not limited to the above embodiment but various modifications thereof may be made. It will be understood by those skilled in the art that various changes in form and detail may made without departing from the scope and spirit of the present invention.

What is claimed is:

1. A spray nozzle structure for use in a massage bathtub comprising:
a housing including a sleeve member having a receiving compartment formed therein and a hollow L-shaped rod member extended upwardly therefrom and communicating with said receiving compartment;
a fixing seat constructed in the form of a ring and fitted in the opening of said sleeve member of said housing;
a motor including a rotary shaft with which an impeller is combined, disposed in said receiving compartment and retained on a peripheral flange of said fixing seat;
a cover member containing an inlet affixed at the center of the outer surface thereof, about which two opposite openings are formed, each having an air duct affixed at the side thereof for flowing air as supplying water.

2. The spray nozzle structure for use in a massage bathtub in claim 1, wherein about said receiving compartment are mounted a plurality of locking pegs, and on said seat is provided with a plurality of holes corresponding to said locking pegs.

3. The spray nozzle structure for use in a massage bathtub as claimed in claim 1, wherein said rod member includes a hooking member attached on the top thereof.

4. The spray nozzle structure for use in a massage bathtub as claimed in claim 1, wherein said fixing seat includes a plurality of retaining recesses fixed on the inner wall of the front end thereof and includes a peripheral flange secured on the rear end thereof, and further includes a plurality of holes and two apertures arranged on the large-diameter stepped end surface thereof, a number of engaging slots defined around the periphery thereof, a fitting rim provided on the back surface thereof, a number of positioning pieces and two inserting pillars disposed on the small-diameter stepped periphery thereof and coupling with said apertures.

5. The spray nozzle structure for use in a massage bathtub as claimed in claim 1, wherein said guiding collar includes a plurality of snap-on tabs mounted around the rim thereof, and includes two opposite protrusions attached on the inner wall thereof for securing said motor.

6. The spray nozzle structure for use in a massage bathtub as claimed in claim 1, wherein on the outer side of each of said openings is mounted a replaceable guiding piece.

7. The spray nozzle structure for use in a massage bathtub as claimed in claim 1, wherein said cover member contains a number of fastening bulges fixed on the inner wall thereof, and contains an inlet affixed at the center of the outer surface thereof, about which two opposite watering grooves are provided and each has an opening and a through orifice for the insertion of a L-shaped air duct, and about each of said watering grooves is formed two opposite dents so as to selectively mount said guiding pieces.

8. The spray nozzle structure for use in a massage bathtub as claimed in claim 1, wherein a plurality of retaining projections may also be directly formed on the periphery of said fixing seat for forming an inlay type spray nozzle, such that said retaining projections may be inserted into the predetermined installing holes on the inner wall of a massage bathtub.
